(19) United States
(12) Patent Application Publication
(10) Pub. No.: US 2026/0002384 A1
(43) Pub. Date: Jan. 1, 2026

(54) CLUTCH MODULE OF ELECTRONIC LOCK AND ELECTRONIC LOCK

(71) Applicant: Shenzhen Yiluo Technology Co., Ltd., Shenzhen (CN)

(72) Inventors: Nianzhong Yao, Shenzhen (CN); Mingyang She, Shenzhen (CN)

(21) Appl. No.: 18/762,971

(22) Filed: Jul. 3, 2024

(30) Foreign Application Priority Data
Jun. 28, 2024 (CN) 202421522916.9

(51) Int. Cl. E05B 47/00

(52) U.S. Cl. CPC E05B 47/0012; E05B 2047/0027

(57) ABSTRACT

A clutch module of an electronic lock includes a housing. The housing is equipped with a lock cylinder connecting member, a first meshing cog, a second meshing cog, a restoring member, a clutch, and a driving device. The lock cylinder connecting member is configured for connecting with a mechanical lock cylinder or a switch knob, and the lock cylinder connecting member is rotatable between a locking position and an unlocking position. The first meshing cog is connected to the lock cylinder connecting member. The second meshing cog is connected to the lock cylinder connecting member. The clutch is connected to restoring member, and the clutch is equipped with a damping device. The driving device is connected to the clutch, and the driving device includes a driving state and a non-driving state.

### CROSS-REFERENCE TO RELATED APPLICATIONS

The application claims priority of Chinese patent application CN202421522916.9, filed on Jun. 28, 2024, which is incorporated herein by reference in its entireties.

### TECHNICAL FIELD

The present invention relates to the field of electronic locks, in particular to a clutch module of an electronic lock and an electronic lock.

### BACKGROUND ART

An electronic lock is a combination of a mechanical device and an electronic control device. The existing intelligent electronic locks widely use an electric clutch, and a motor controls the clutch to fit with a next cog to achieves the purpose of automatic unlocking or locking. However, in most of the existing electronic locks on the market, when a sudden power failure occurs, the electronic control device part will fail or be damaged, which will lead to cog jamming, thereby causing a mechanical key to be unable to unlock the door or a knob switch of an internal lock body to be unable to rotate, easily causing unpredictable disasters such as inability to open the door in the event of a fire.

Therefore, a clutch module of an electronic lock and an electronic lock are provided in the present invention. The clutch structure in the electronic lock can be used independently with the mechanical unlocking device in any unexpected situation, so as not to cause jamming of the clutch and the meshing cog, thereby ensuring the safety of the electronic lock.

### SUMMARY

In order to overcome the shortcomings of the prior art, a clutch module of an electronic lock and an electronic lock are provided in the present invention. The clutch structure in the electronic lock can be used independently with a mechanical unlocking device in any unexpected situation, so as not to cause jamming of the clutch and a meshing cog, ensuring the safety of the electronic lock.

The technical solution adopted by the present invention to solve its technical problem is as follows.

A clutch module of an electronic lock includes a housing. The housing is equipped with a lock cylinder connecting member, a first meshing cog, a second meshing cog, a restoring member, a clutch, and a driving device. The lock cylinder connecting member is configured for connecting with a mechanical lock cylinder or a switch knob, and the lock cylinder connecting member is rotatable between a locking position and an unlocking position. The first meshing cog is connected to the lock cylinder connecting member. The second meshing cog is connected to the lock cylinder connecting member. The clutch is connected to restoring member, and the clutch is equipped with a damping device. The driving device is connected to the clutch, and the driving device includes a driving state and a non-driving state.

When the driving device is in the driving state, the driving device drives the clutch to be connected to the first meshing cog or the second meshing cog, and the driving device drives the first meshing cog or the second meshing cog to rotate, thereby driving the lock cylinder connecting member to rotate to the locking position or the unlocking position.

When the driving device is in the non-driving state, the restoring member causes the clutch to disengage from the first meshing cog or the second meshing cog.

As an improvement of the present invention, the clutch includes an upper cover body, a lower cover body, a clutch input cog, and a clutch output cog. The upper cover body is connected to the lower cover body to form an installation cavity. The clutch input cog, the clutch output cog, and the damping device are provided inside the installation cavity.

As an improvement of the present invention, the damping device is positioned between the upper cover body and the clutch output cog.

As an improvement of the present invention, the damping device is a damping spring. The damping spring abuts against the upper cover body and the clutch output cog through elastic force.

As an improvement of the present invention, the damping spring is a cylindrical spring. The damping spring is provided with an upper end and a lower end. The upper cover body is equipped with a first position limiting slot, and the clutch output cog is equipped with a second position limiting slot. The upper end is pressed against the first position limiting slot, and the lower end is pressed against the second position limiting slot.

As an improvement of the present invention, the restoring member is an elastic restoring member. One end of the elastic restoring member is connected to the housing, and an opposite end of the elastic restoring member is connected to the clutch. When the driving device stops driving, the clutch disengages from the first meshing cog or the second meshing cog under an elastic restoring force of the elastic restoring member.

As an improvement of the present invention, the elastic restoring member is a restoring elastic sheet clip. The restoring elastic sheet clip includes a first elastic sheet arm and a second elastic sheet arm. The upper cover body is convex to form a first rocking arm, and the lower cover body is convex to form a second rocking arm. The first elastic sheet arm and the second elastic sheet arm clamp the first rocking arm or the second rocking arm through elastic force.

As an improvement of the present invention, the restoring elastic sheet clip is in a “U” shape.

As an improvement of the present invention, the restoring member further includes a fixed convex block and a fixed plate both arranged on the housing. The restoring elastic sheet clip is sleeved on the fixed convex block, and the fixed plate fixes and presses the restoring elastic sheet clip tightly against the fixed convex block.

As an improvement of the present invention, the driving device includes a motor and a motor output cog. The motor is configured for driving the motor output cog to rotate, and the motor output cog is engaged and connected with the clutch input cog.

As an improvement of the present invention, the clutch is engaged and connected with the first meshing cog or the second meshing cog through the clutch output cog.

As an improvement of the present invention, the housing is further equipped with a speed changing gear group. The first meshing cog and the second meshing cog are engaged and connected with the speed changing gear group. The speed changing gear group is connected to the lock cylinder connecting member, so that the driving device drives the first meshing cog to rotate, and drives the lock cylinder connecting member to rotate to the locking position or the unlocking position through the speed changing gear group.

As an improvement of the present invention, the lock cylinder connecting member includes a lock cylinder output cog and a lock cylinder connecting shaft fixedly connected to the lock cylinder output cog. The lock cylinder output cog is engaged and connected to the speed changing gear group, and the lock cylinder connecting shaft is configured for connecting with the mechanical lock cylinder or the switch knob.

As an improvement of the present invention, the clutch module further includes a control motherboard. The control motherboard is electrically connected to the driving device to drive the driving device to be in the driving state or the non-driving state.

As an improvement of the present invention, the clutch module further includes a switch detection module. When the switch detection module detects that the lock cylinder connecting member is in the locking position or the unlocking position, the control motherboard is used for controlling the driving device to be in the non-driving state.

As an improvement of the present invention, the switch detection module includes at least two photoelectric detection devices and a light blocking member. At least two of the photoelectric detection devices are positioned on the control motherboard, and the light blocking member is positioned on the lock cylinder output cog.

As an improvement of the present invention, the switch detection module includes a first photoelectric detection device and a second photoelectric detection device. The first photoelectric detection device is positioned on the control motherboard and corresponds to the locking position. The second photoelectric detection device is positioned on the control motherboard and corresponds to the unlocking position. The light blocking member is configured for rotating between the first photoelectric detection device and the second photoelectric detection device. When the light blocking member rotates to a position of the first photoelectric detection device, the control motherboard controls the driving device to stop driving, and at this time the electronic lock is in a locked state. When the light blocking member rotates to a position of the second photoelectric detection device, the control motherboard controls the driving device to stop driving, and at this time the electronic lock is in an unlocked state.

As an improvement of the present invention, the control motherboard is further equipped with a third photoelectric detection device. The third photoelectric detection device corresponds to the locking position.

An electronic lock is further provided in the present invention, including the clutch module of the electronic lock as described above.

Beneficial effects of the present invention are as follows. The clutch module of the electronic lock is provided in the present invention, and the clutch module includes the housing. The housing is equipped with the lock cylinder connecting member, the first meshing cog, the second meshing cog, the restoring member, the clutch, and the driving device. The lock cylinder connecting member is configured for connecting with the mechanical lock cylinder or the switch knob, and the lock cylinder connecting member is rotatable between the locking position and the unlocking position. The first meshing cog is connected to the lock cylinder connecting member. The second meshing cog is connected to the lock cylinder connecting member. The clutch is connected to restoring member, and the clutch is equipped with the damping device. The driving device is connected to the clutch, and the driving device includes the driving state and the non-driving state. When the driving device is in the driving state, the driving device drives the clutch to be connected to the first meshing cog or the second meshing cog, and the driving device drives the first meshing cog or the second meshing cog to rotate, thereby driving the lock cylinder connecting member to rotate to the locking position or the unlocking position. When the driving device is in the non-driving state, the restoring member causes the clutch to disengage from the first meshing cog or the second meshing cog. Through the above structure, since the clutch is equipped with the damping device, the driving device can drive the clutch to be connected to the first meshing cog or the second meshing cog. Under the drive of the driving device, the first meshing cog or the second meshing cog drives the lock cylinder connecting member to rotate to the locking position or the unlocking position to achieve the purpose of automatic unlocking or locking. Compared with the prior art, since the restoring member is provided, after achieving the purpose of unlocking or locking or when an electronic failure occurs, the driving device stops driving, the restoring member can make the clutch quickly disengage from the first meshing cog or the second meshing cog, so that the clutch will not engage with the first meshing cog or the second meshing cog all the time. At this time, the electronic lock can be unlocked by inserting a key into the mechanical lock cylinder or rotating the switch knob, safeguarding the use of the mechanical key and improving the safety and reliability of the electronic lock.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of an overall structure of a clutch module of the present invention;

FIG. 2 is a schematic diagram of the clutch module with an outer housing opened according to the present invention;

FIG. 3 is a top view of the clutch module with an upper cover of the clutch removed according to the present invention;

FIG. 4 is an exploded view of the clutch module of the present invention;

FIG. 5 is a sectional view of the clutch module of the present invention across the clutch;

FIG. 6 is a schematic diagram of a structure of a switch detection module of the clutch module according to the present invention;

FIG. 7 is a usage state diagram of an electronic lock of the present invention;

FIG. 8 is a schematic diagram of a structure of the electronic lock of the present invention; and

FIG. 9 is an exploded view of the electronic lock of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

### Embodiment One

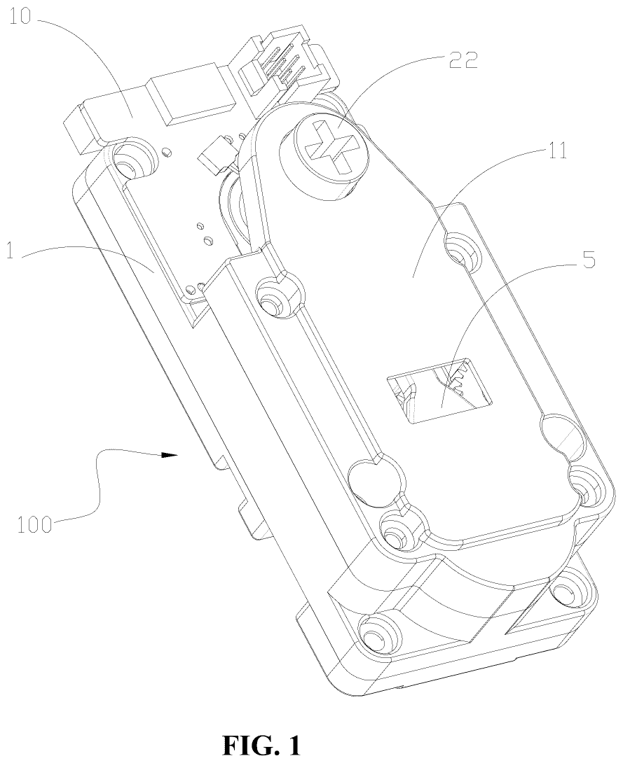

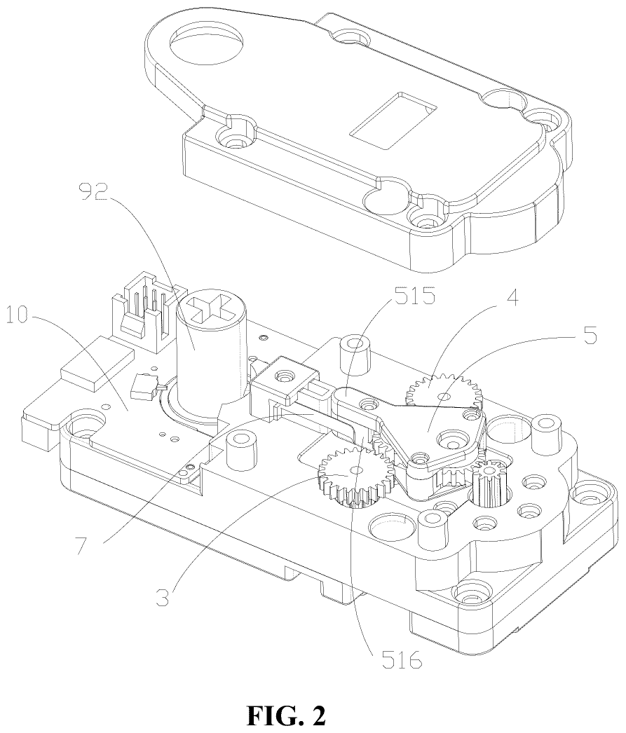

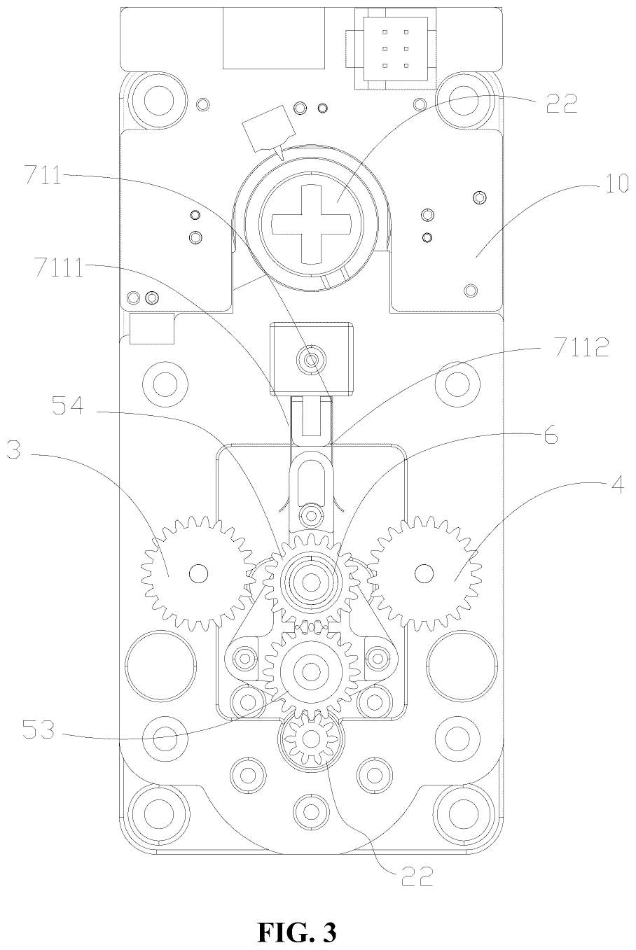

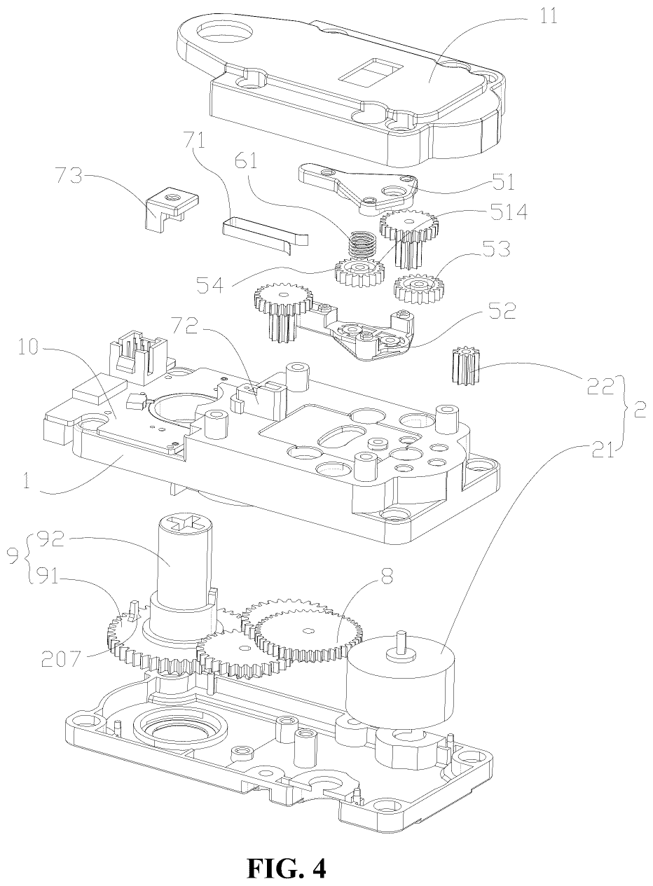

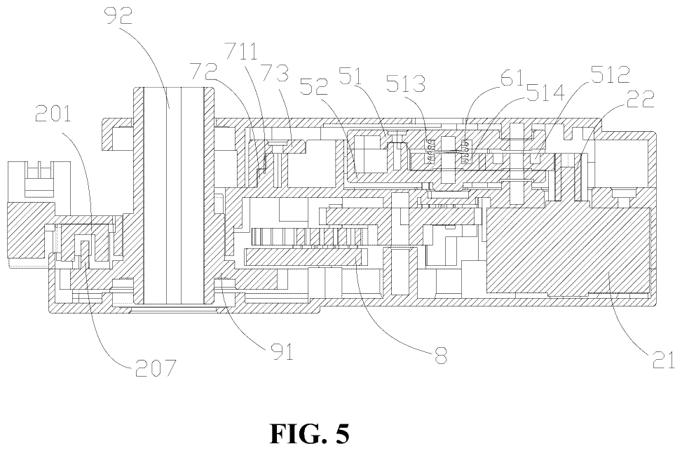

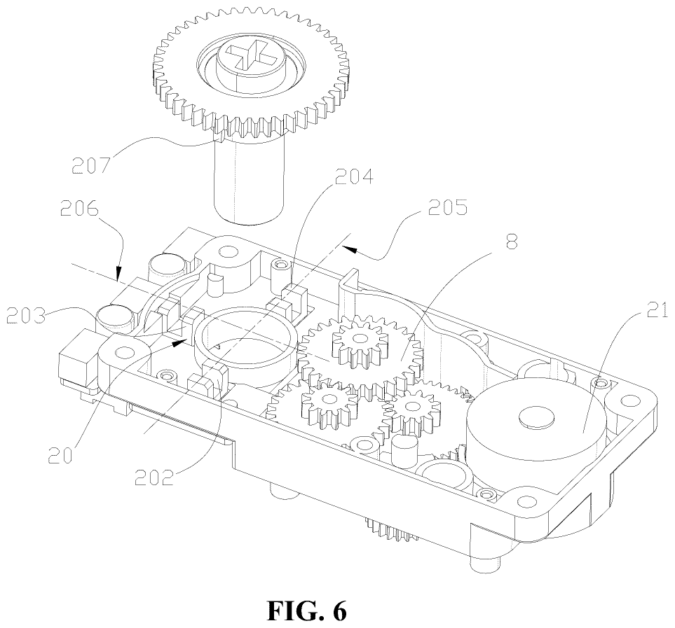

Referring to FIGS. 1-6, a clutch module 100 of an electronic lock includes a housing 1. The housing 1 is equipped with a lock cylinder connecting member 9, a first meshing cog 3, a second meshing cog 4, a restoring member 7, a clutch 5, and a driving device 2. The lock cylinder connecting member 9 is configured for connecting with a mechanical lock cylinder 210 or a switch knob 410, and the lock cylinder connecting member 9 is rotatable between a locking position and an unlocking position. The first meshing cog 3 is connected to the lock cylinder connecting member 9. The second meshing cog 4 is connected to the lock cylinder connecting member 9. The clutch 5 is connected to the restoring member 7, and the clutch 5 is equipped with a damping device 6. The driving device 2 is connected to the clutch 5, and the driving device 2 includes a driving state and a non-driving state. When the driving device 2 is in the driving state, the driving device 2 drives the clutch 5 to be connected to the first meshing cog 3 or the second meshing cog 4, and the driving device 2 drives the first meshing cog 3 or the second meshing cog 4 to rotate, thereby driving the lock cylinder connecting member 9 to rotate to the locking position or the unlocking position. When the driving device 2 is in the non-driving state, the restoring member 7 causes the clutch 5 to disengage from the first meshing cog 3 or the second meshing cog 4.

Through the above structure, since the clutch 5 is equipped with the damping device 6, the driving device 2 can drive the clutch 5 to be connected to the first meshing cog 3 or the second meshing cog 4. Under the drive of the driving device 2, the first meshing cog 3 or the second meshing cog 4 drives the lock cylinder connecting member 9 to rotate to the locking position or the unlocking position to achieve the purpose of automatic unlocking or locking. Compared with the prior art, since the restoring member 7 is provided, after achieving the purpose of unlocking or locking or when an electronic failure occurs, the driving device 2 stops driving, the restoring member 7 can make the clutch 5 quickly disengage from the first meshing cog 3 or the second meshing cog 4, so that the clutch 5 will not engage with the first meshing cog 3 or the second meshing cog 4 all the time. At this time, the electronic lock can be unlocked by inserting a key into the mechanical lock cylinder 210 or rotating the switch knob 410, safeguarding the use of the mechanical key and improving the safety and reliability of the electronic lock.

In this embodiment, the clutch 5 includes an upper cover body 51, a lower cover body 52, a clutch input cog 53, and a clutch output cog 54. The upper cover body 51 is connected to the lower cover body 52 to form an installation cavity 512. The clutch input cog 53, the clutch output cog 54, and the damping device 6 are provided inside the installation cavity 512. Specifically, the damping device 6 is positioned between the upper cover body 51 and the clutch output cog 54. Through the above structure, due to the damping device 6 being set between the upper cover body 51 and the clutch output cog 54, there is a large frictional force between the clutch output cog 54 and the upper cover body 51. When the driving device 2 drives the clutch input cog 53 to rotate, the clutch output cog 54 will generate a relatively large reaction force relative to the clutch input cog 53 to push the clutch 5 to swing left and right with the clutch input cog 53 as the center, so that the driving device 2 controls the clutch 5 to be connected with the first meshing cog 3 or the second meshing cog 4.

Furthermore, the driving device 2 includes a motor 21 and a motor output cog 22. The motor 21 is configured for driving the motor output cog 22 to rotate, and the motor output cog 22 is engaged and connected with the clutch input cog 53. The clutch 5 is engaged and connected with the first meshing cog 3 or the second meshing cog 4 through the clutch output cog 54. Through the above structure, under the reaction force of the damping device 6, when the motor output cog 22 rotates in a direction of the first meshing cog 3, the clutch 5 will swing towards the direction of the first meshing cog 3 with the clutch input cog 53 as the center, and stops swinging when the clutch output cog 54 meshes with the first meshing cog 3. When the motor output cog 22 rotates in a direction of the second meshing cog 4, the clutch 5 will swing towards the direction of the second meshing cog 4 with the clutch input cog 53 as the center, and stop swinging when the clutch output cog 54 meshes with the second meshing cog 4.

Furthermore, the locking position includes a first locking position and a second locking position. The first locking position and the second locking position are positioned in a first axis direction 205, and the unlocking position is positioned in a second axis direction 206. The first axis direction 205 is different from the second axis direction 206. The unlocking position is positioned in a vertical direction, the first locking position and the second locking position are positioned in a transverse direction, and the first locking position and the second locking position are symmetrically disposed with the second axis direction 206 as an axis of symmetry, so as to enable the clutch module to be used on doors in different opening directions.

Specifically, when an opening direction of the door is a first direction, and at this time when the lock cylinder connecting member 9 rotates to the first locking position, the door is in a locked state. The driving device 2 drives the clutch 5 to connect with the first meshing cog 3 and drives the first meshing cog 3 to rotate, thereby driving the lock cylinder connecting member 9 to rotate to the first locking position. The driving device 2 drives the clutch 5 to connect with the second meshing cog 4 and drives the second meshing cog 4 to rotate, thereby driving the lock cylinder connecting member 9 to rotate to the unlocking position. Similarly, when the opening direction of the door is a second direction opposite to the first direction, and at this time when the lock cylinder connecting member 9 rotates to the second locking position, the door is in the locked state. The driving device 2 drives the clutch 5 to connect with the second meshing cog 4 and drives the second meshing cog 4 to rotate, thereby driving the lock cylinder connecting member 9 to rotate to the second locking position. The driving device 2 drives the clutch 5 to connect with the first meshing cog 3 and drives the first meshing cog 3 to rotate, thereby driving the lock cylinder connecting member 9 to rotate to the unlocking position.

That is, whether the lock cylinder connecting member 9 rotates to the left or right, when it reaches the locking position, the automatic locking setting of the electronic lock can be achieved, so that the adaptability of the clutch module of the electronic lock is improved, and the user experience is greatly enhanced.

In this embodiment, the damping device 6 is a damping spring 61. The damping spring 61 abuts against the upper cover body 51 and the clutch output cog 54 through elastic force. Furthermore, the damping spring 61 is a cylindrical spring. The damping spring 61 is provided with an upper end and a lower end. The upper cover body 51 is equipped with a first position limiting slot 513, and the clutch output cog 54 is equipped with a second position limiting slot 514. The upper end is pressed against the first position limiting slot 513, and the lower end is pressed against the second position limiting slot 514. Through the above structure, the two ends of the cylindrical damping spring 61 are respectively pressed against the first position limiting slot 513 of the upper cover body 51 and the second position limiting slot 514 of the clutch output cog 54, ensuring that the damping spring 61 will not displace or fall off during operation, improving the stability and reliability of the entire damping device 6. The design and installation structure of the damping device 6 is simple, reducing process difficulty and improving production efficiency.

In this embodiment, the restoring member 7 is an elastic restoring member 71. One end of the elastic restoring member 71 is connected to the housing 1, and an opposite end of the elastic restoring member 71 is connected to the clutch 5. When the driving device 2 stops driving, the clutch 5 disengages from the first meshing cog 3 or the second meshing cog 4 under an elastic restoring force of the elastic restoring member 71.

Specifically, the elastic restoring member 71 is a restoring elastic sheet clip 711. The restoring elastic sheet clip 711 includes a first elastic sheet arm 7111 and a second elastic sheet arm 7112. The upper cover body 51 is convex to form a first rocking arm 515, and the lower cover body 52 is convex to form a second rocking arm 516. The first elastic sheet arm 7111 and the second elastic sheet arm 7112 clamp the first rocking arm 515 or the second rocking arm 516 through elastic force. Through the above structure, when the motor 21 stops rotating for various reasons, such as the unlocking or locking purpose of the electronic lock being achieved, or unpredictable faults such as fire and power outage occurring, the motor output cog 22 stops rotating. At this time, the clutch input cog 53 engaged and connected to the motor output cog 22 also stops rotating. Without the driving force of the motor 21, the restoring elastic sheet clip 711 clamping to the first rocking arm 515 or the second rocking arm 516 of the clutch 5, under the action of the restoring elastic force, disengages the clutch 5 from the first meshing cog 3 or the second meshing cog 4 and restores the clutch 5 to an initial position, ensuring that the mechanical lock cylinder 210 used for key unlocking is not affected by the clutch 5, allowing the mechanical key to perform the operation of unlocking independently, thereby enhancing the security and reliability of the electronic lock.

In this embodiment, the restoring elastic sheet clip 711 is in a “U” shape. The restoring member 7 further includes a fixed convex block 72 and a fixed plate 73 both arranged on the housing 1. The restoring elastic sheet clip 711 is sleeved on the fixed convex block 72, and the fixed plate 73 fixes and presses the restoring elastic sheet clip 711 tightly against the fixed convex block 72. Through the above structure, the setting of the fixed convex block 72 and the fixed plate 73 ensures that the U-shaped restoring elastic sheet clip 711 is firmly fixed on the housing 1, avoiding displacement or loosening of the elastic sheet clip due to vibration or external force during operation, thereby improving stability and reliability.

In this embodiment, the housing 1 is further equipped with a speed changing gear group 8. The first meshing cog 3 and the second meshing cog 4 are engaged and connected with the speed changing gear group 8. The speed changing gear group 8 is connected to the lock cylinder connecting member 9, so that the driving device 2 drives the first meshing cog 3 to rotate, and drives the lock cylinder connecting member 9 to rotate to the locking position or the unlocking position through the speed changing gear group 8.

Furthermore, the lock cylinder connecting member 9 includes a lock cylinder output cog 91 and a lock cylinder connecting shaft 92 fixedly connected to the lock cylinder output cog 91. The lock cylinder output cog 91 is engaged and connected to the speed changing gear group 8, and the lock cylinder connecting shaft 92 is configured for connecting with the mechanical lock cylinder 210 or the switch knob 410. Through the above structure, when the clutch output cog 54 is engaged and connected to the first meshing cog 3 or the second meshing cog 4 and rotates, the first meshing cog 3 or the second meshing cog 4 drives the speed changing gear group 8 to rotate, thereby driving the lock cylinder output cog 91 to rotate, ultimately achieving that the lock cylinder connecting shaft 92 drives the mechanical lock cylinder 210 or the switch knob 410 to open or close the electronic lock.

In this embodiment, the clutch module 100 further includes a control motherboard 10. The control motherboard 10 is electrically connected to the driving device 2 to drive the driving device 2 to be in the driving state or the non-driving state.

Furthermore, the clutch module 100 further includes a switch detection module 20. When the switch detection module 20 detects that the lock cylinder connecting member 9 is in the locking position or the unlocking position, the control motherboard 10 is used for controlling the driving device 2 to be in the non-driving state.

The switch detection module 20 includes at least two photoelectric detection devices 201 and a light blocking member 207. At least two of the photoelectric detection devices 201 are positioned on the control motherboard 10, and the light blocking member 207 is positioned on the lock cylinder output cog 91. Through the above structure, since the light blocking member 207 is positioned on the lock cylinder output cog 91, the light blocking member 207 can rotate together when the clock cylinder output cog 91 rotates. At this time, the light blocking member 207 plays an auxiliary detection role. When the light blocking member 207 rotates to the position of the photoelectric detection device 201, the photoelectric detection device 201 can receive an induction signal and transmit the induction signal to the control motherboard 10. The control motherboard 10 can sense whether the lock cylinder connecting member 9 is in the unlocking position or the locking position, thereby controlling the motor 21 to stop driving.

In this embodiment, the switch detection module 20 includes a first photoelectric detection device 202 and a second photoelectric detection device 203. The first photoelectric detection device 202 is positioned on the control motherboard 10 and corresponds to the locking position. The second photoelectric detection device 203 is positioned on the control motherboard 10 and corresponds to the unlocking position. The light blocking member 207 is configured for rotating between the first photoelectric detection device 202 and the second photoelectric detection device 203. When the light blocking member 207 rotates to the position the first photoelectric detection device 202, the control motherboard 10 controls the driving device 2 to stop driving. At this time, the electronic lock is in a locked state. When the light blocking member 207 rotates to a position of the second photoelectric detection device 203, the control motherboard 10 controls the driving device 2 to stop driving, at this time the electronic lock is in an unlocked state. Through the above structure, since the first photoelectric detection device 202 is arranged at the first locking position of the lock cylinder connecting member 9, when the light blocking member 207 rotates to a position of the first photoelectric detection device 202, the control motherboard 10 can recognize that the lock cylinder connecting shaft 92 has rotated to the first locking position through the induction signal sent by the first photoelectric detection device 202, and then control the motor 21 to stop driving. Similarly, when the light blocking member 207 rotates to the position of the second photoelectric detection device 203, the control motherboard 10 can recognize that the lock cylinder connecting shaft 92 has rotated to the unlocking position through the induction signal sent by the second photoelectric detection device 203, and then effectively control the motor 21 to automatically stop driving.

In this embodiment, the control motherboard 10 is further equipped with a third photoelectric detection device 204. The third photoelectric detection device 204 corresponds to the second locking position, so as to enable the clutch module to be used on doors in different opening directions. That is, whether the lock cylinder connecting shaft 92 rotates to the left or right, when it reaches the locking position, the setting of automatic locking of the electronic lock can be achieved, improving the adaptability of the clutch module of the electronic lock, and greatly enhancing the user experience.

In this embodiment, the clutch module of the electronic lock is also electrically connected to a wireless module. The wireless module is configured for connecting with external devices. Specifically, the wireless module can be Bluetooth, WiFi, infrared, etc. Through the above structure, a user can use a remote control or an APP in a mobile phone, etc. to connect to the clutch module of the electronic lock through wireless connections such as Bluetooth, WiFi, or infrared, so as to check the status of locking and unlocking of the electronic lock at any time or control the opening or closing of the electronic lock. Remote control operation saves the trouble of traditional mechanical keys, making the electronic lock easily integrated into a smart home system and improving an overall level of intelligence.

In this embodiment, the clutch module of the electronic lock is further equipped with an outer housing 11. The outer housing 11 protects each part inside, and has the effect of protecting parts and preventing interference from other devices.

### Embodiment Two

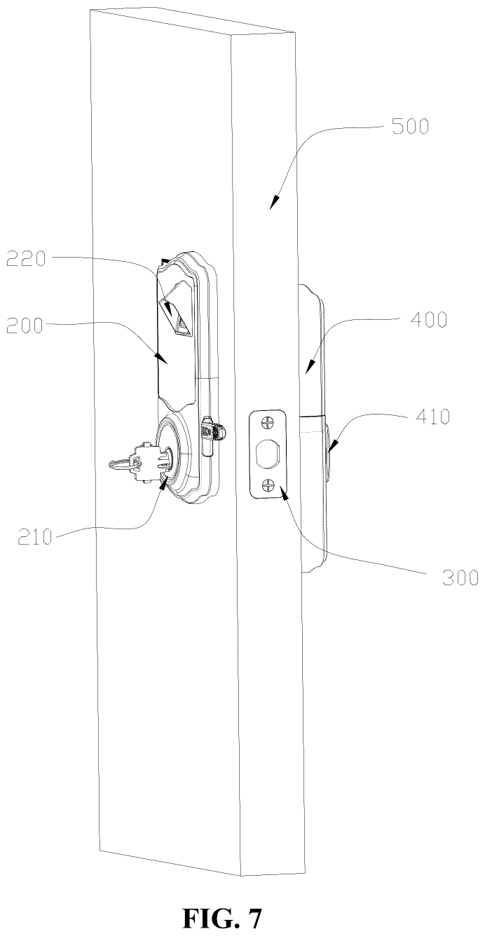

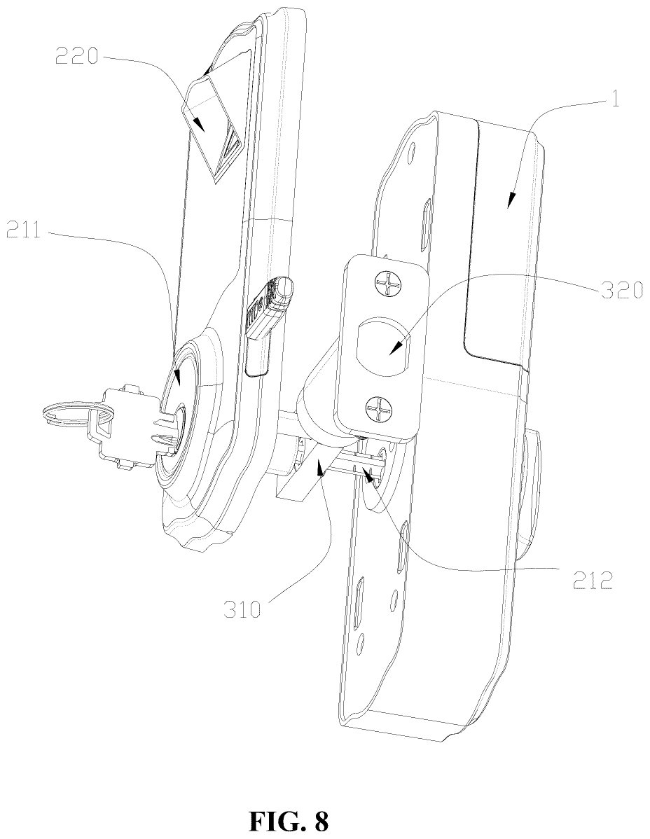

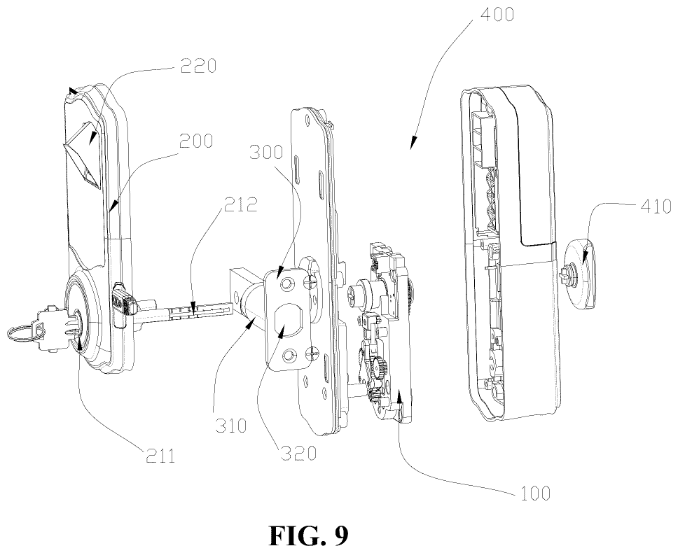

Referring to FIGS. 1-9, an electronic lock includes the clutch module 100 of the electronic lock in embodiment one, an external lock body 200, a door internal lock body 300, and an internal lock body 400.

The external lock body is installed on an outside of a door body 500, the door internal lock body 300 is installed inside the door body 500, and the internal lock body 400 is installed on an inside of the door.

In this embodiment, the external lock body includes a mechanical lock cylinder 210 and a fingerprint recognition device 220. The mechanical lock cylinder 210 includes a lock cylinder 211 for receiving a key and a lock bar 212 connected to and synchronously rotating with the lock cylinder.

The internal lock body 400 includes the clutch module 100 and a switch knob 410. The lock bar 212 and the switch knob 410 are connected to a lock cylinder connecting shaft in the clutch module 100 and rotate synchronously.

The door internal lock body 300 includes a door bolt 310. The door bolt 310 includes a stop block 320. The door bolt 310 is sleeved on the lock bar. The stop block 320 moves out or retracts with the rotation of the lock bar 212. When the stop block 320 moves out, the electronic lock is in a locked state, and when the stop block retracts, the electronic lock is in an unlocked state.

Through the above structure, when a user presses the fingerprint recognition device 220, the control circuit board 10 in the clutch module 100 can receive a signal and start the motor to drive the clutch 5 to engage with the first meshing cog 3 or the second meshing cog 4, thereby driving the lock cylinder connecting shaft 92 to rotate to the unlocking position and the locking position, achieving automatic unlocking and locking functions. If the user does not want to use fingerprint to unlock the door, the user can insert a key into the lock cylinder and rotate the lock bar to achieve the purpose of unlocking and locking. When the electronic lock fails, for example, when the driving device cannot be driven after the electronic lock runs out of power, the door can be unlocked or locked by inserting the key into the lock cylinder or turning the switch knob 410, ensuring that the electronic lock can use the mechanical unlocking function in case of no power or failure or other situations, thereby ensuring the safety of the electronic lock.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A clutch module of an electronic lock, comprising a housing, wherein the housing is equipped with:
a lock cylinder connecting member, the lock cylinder connecting member being configured for connecting with a mechanical lock cylinder or a switch knob, and the lock cylinder connecting member being rotatable between a locking position and an unlocking position;
a first meshing cog, the first meshing cog being connected to the lock cylinder connecting member;
a second meshing cog, the second meshing cog being connected to the lock cylinder connecting member;
a restoring member;
a clutch, the clutch being connected to restoring member, and the clutch being equipped with a damping device; and
a driving device, the driving device being connected to the clutch, and the driving device comprising a driving state and a non-driving state;
wherein when the driving device is in the driving state, the driving device drives the clutch to be connected to the first meshing cog or the second meshing cog, and the driving device drives the first meshing cog or the second meshing cog to rotate, thereby driving the lock cylinder connecting member to rotate to the locking position or the unlocking position;
when the driving device is in the non-driving state, the restoring member causes the clutch to disengage from the first meshing cog or the second meshing cog.

2. The clutch module of the electronic lock according to claim 1, wherein the clutch comprises an upper cover body, a lower cover body, a clutch input cog, and a clutch output cog; the upper cover body is connected to the lower cover body to form an installation cavity; the clutch input cog, the clutch output cog, and the damping device are provided inside the installation cavity.

3. The clutch module of the electronic lock according to claim 2, wherein the damping device is positioned between the upper cover body and the clutch output cog.

4. The clutch module of the electronic lock according to claim 3, wherein the damping device is a damping spring, and the damping spring abuts against the upper cover body and the clutch output cog through elastic force.

5. The clutch module of the electronic lock according to claim 4, wherein the damping spring is a cylindrical spring, the damping spring is provided with an upper end and a lower end, the upper cover body is equipped with a first position limiting slot, the clutch output cog is equipped with a second position limiting slot, the upper end is pressed against the first position limiting slot, and the lower end is pressed against the second position limiting slot.

6. The clutch module of the electronic lock according to claim 1, wherein the restoring member is an elastic restoring member, one end of the elastic restoring member is connected to the housing, and an opposite end of the elastic restoring member is connected to the clutch; when the driving device stops driving, the clutch disengages from the first meshing cog or the second meshing cog under an elastic restoring force of the elastic restoring member.

7. The clutch module of the electronic lock according to claim 6, wherein the elastic restoring member is a restoring elastic sheet clip, the restoring elastic sheet clip comprises a first elastic sheet arm and a second elastic sheet arm, the upper cover body is convex to form a first rocking arm, the lower cover body is convex to form a second rocking arm, and the first elastic sheet arm and the second elastic sheet arm clamp the first rocking arm or the second rocking arm through elastic force.

8. The clutch module of the electronic lock according to claim 7, wherein the restoring elastic sheet clip is in a “U” shape.

9. The clutch module of the electronic lock according to claim 8, wherein the restoring member further comprises a fixed convex block and a fixed plate both arranged on the housing, the restoring elastic sheet clip is sleeved on the fixed convex block, and the fixed plate fixes and presses the restoring elastic sheet clip tightly against the fixed convex block.

10. The clutch module of the electronic lock according to claim 2, wherein the driving device comprises a motor and a motor output cog, the motor is configured for driving the motor output cog to rotate, and the motor output cog is engaged and connected with the clutch input cog.

11. The clutch module of the electronic lock according to claim 2, wherein the clutch is engaged and connected with the first meshing cog or the second meshing cog through the clutch output cog.

12. The clutch module of the electronic lock according to claim 2, wherein the housing is further equipped with a speed changing gear group, the first meshing cog and the second meshing cog are engaged and connected with the speed changing gear group, and the speed changing gear group is connected to the lock cylinder connecting member, so that the driving device drives the first meshing cog to rotate, and drives the lock cylinder connecting member to rotate to the locking position or the unlocking position through the speed changing gear group.

13. The clutch module of the electronic lock according to claim 12, wherein the lock cylinder connecting member comprises a lock cylinder output cog and a lock cylinder connecting shaft fixedly connected to the lock cylinder output cog, the lock cylinder output cog is engaged and connected to the speed changing gear group, and the lock cylinder connecting shaft is configured for connecting with the mechanical lock cylinder or the switch knob.

14. The clutch module of the electronic lock according to claim 13, further comprising a control motherboard, wherein the control motherboard is electrically connected to the driving device to drive the driving device to be in the driving state or the non-driving state.

15. The clutch module of the electronic lock according to claim 14, further comprising a switch detection module, wherein when the switch detection module detects that the lock cylinder connecting member is in the locking position or the unlocking position, the control motherboard is used for controlling the driving device to be in the non-driving state.

16. The clutch module of the electronic lock according to claim 15, wherein the switch detection module comprises at least two photoelectric detection devices and a light blocking member, at least two of the photoelectric detection devices are positioned on the control motherboard, and the light blocking member is positioned on the lock cylinder output cog.

17. The clutch module of the electronic lock according to claim 16, wherein the switch detection module comprises a first photoelectric detection device and a second photoelectric detection device, the first photoelectric detection device is positioned on the control motherboard and corresponds to the locking position, the second photoelectric detection device is positioned on the control motherboard and corresponds to the unlocking position, and the light blocking member is configured for rotating between the first photoelectric detection device and the second photoelectric detection device; when the light blocking member rotates to a position of the first photoelectric detection device, the control motherboard controls the driving device to stop driving, and at this time the electronic lock is in a locked state; when the light blocking member rotates to a position of the second photoelectric detection device, the control motherboard controls the driving device to stop driving, and at this time the electronic lock is in an unlocked state.

18. The clutch module of the electronic lock according to claim 17, wherein the control motherboard is further equipped with a third photoelectric detection device, and the third photoelectric detection device corresponds to the locking position.

19. The clutch module of the electronic lock according to claim 17, further comprising a wireless module, the wireless module is electrically connected to the control motherboard, and the wireless module is configured for connecting with external devices.

20. An electronic lock, comprising the clutch module of the electronic lock according to claim 1.
